(19) United States
(12) Patent Application Publication
(10) Pub. No.: US 2023/0062261 A1
(43) Pub. Date: Mar. 2, 2023

(54) POLYUREA COPOLYMER

(71) Applicant: BASF SE, Ludwigshafen am Rhein (DE)

(72) Inventors: Sandra Gloria KOENIG, Ludwigshafen am Rhein (DE); Aggeliki QUELL, Ludwigshafen am Rhein (DE); Jean-Pierre Berkan LINDNER, Ludwigshafen am Rhein (DE); Michael ZEILINGER, Ludwigshafen am Rhein (DE); Dag WIEBELHAUS, Ludwigshafen am Rhein (DE)

(21) Appl. No.: 17/784,128

(22) PCT Filed: Dec. 14, 2020
(86) PCT No.: PCT/EP2020/086013

§ 371 Date: Jun. 10, 2022

(30) Foreign Application Priority Data
Dec. 17, 2019 (EP) 19216758.3

(51) Int. Cl. C08L 75/02; C08G 18/08; C08G 18/32; C08G 18/76

(52) U.S. Cl. CPC C08L 75/02; C08G 18/0852; C08G 18/3234; C08G 18/325; C08G 18/7664; C08G 2280/00

(57) ABSTRACT

The presently claimed invention is directed to a polyurea copolymer obtained by reacting an isocyanate mixture and at least one at least one secondary amine having at least two amine functionalities; wherein the isocyanate mixture (A) has an average NCO functionality of ≥2.10.

### FIELD OF INVENTION

The presently claimed invention is directed to a polyurea copolymer obtained by reacting an isocyanate mixture and at least one secondary amine having at least two amine functionalities; wherein the isocyanate mixture (A) has an average NCO functionality of ≥2.10.

### BACKGROUND OF INVENTION

There is a need in the material and polymer sciences to develop polymeric materials with desired in-use performance characteristics that are also malleable, repairable, and shape reprogrammable. There is also a need to develop such polymers that can be degraded or reversibly depolymerized. Even though shape memory and self-healing polymers are known, many of these polymers do not have both the desired performance and dynamic characteristics. For example, many shape memory polymers, which depend on the formation of covalent crosslinks, cannot be processed, reprogrammed, or recycled after the permanent shape is set by covalent crosslinking. With respect to degradable or reversibly depolymerizable polymers, these polymers often lack the required in-use performance characteristics and are either too easily degraded or on the other hand not degraded as readily or rapidly as desired.

Differing from polymers formed with strong, irreversible covalent bonds and stable bulk properties, polymers prepared through reversible non-covalent interactions or covalent bonds exhibit various dynamic properties. The dynamic features of reversible polymers have been employed in the design of self-healing, shape-memory, and environmentally adaptive materials. However, non-covalent interactions are relatively weak, with only a few exceptions such as quadruple hydrogen bonding, high valence metal chelation, and host-guest molecular interactions. Dynamic covalent bonds, on the contrary, usually have higher strength and more controllable reversibility.

Introducing bulky substituents has been theorized to create steric hindrance to disturb the orbital co-planarity of the amide bond, which diminishes the conjugation effect and thus weakens the carbonyl-amine interaction. However, the dissociated intermediate from amidolysis, would be a ketene, and if formed would generally be too reactive to provide dynamic reversible formation of the amide bond. To make the carbonyl-amine structure reversible, it is required that the dissociated carbonyl structure be stable under ambient conditions, but still highly reactive with amines. One such functional group that satisfies these requirements is the isocyanate group, which can be used to form urea linkages. Isocyanates are generally sufficiently stable under ambient conditions and can react with amines rapidly to form a urea bond, a reaction that has been broadly used in the synthesis of polyurea and poly(urethane-urea). Therefore, it would be highly desirable to control the reversibility and the kinetics of these urea bonds in polymeric materials.

Polymers can be formed from the reaction of one or more isocyanates with one or more amines. These polymers can be formed by bringing the isocyanates in contact with the amines using static mixing equipment, high-pressure impingement mixing equipment, low-pressure mixing equipment, roller with mixing attachments and simple hand mixing techniques. These polymers are useful in caulks, adhesives, sealants, coatings, foams, and many other applications. Specific examples include, but are not limited to, truck-bed liners, concrete coatings, and molded articles.

US 2007/0208156 A1 discloses polyurea, polyurethane, and polyurea-polyurethane hybrid, made from an isocyanate, a secondary polyetheramine, a second amine, and optionally a polyol. The secondary polyetheramine may be used in combination with the second amine to modify other properties of the polymer, including its cure time and cost. The secondary polyetheramine comprises secondary polyoxyalkylene amines.

US 2016/0030254 A1 discloses a reversible polymer that is formed from polyurea by modifying the nitrogen atom with hindered substituents. The reversibility of the hindered urea bond is controlled by changing the bulkiness of the substituents. The selection of hindered urea polymer with its high binding constant and short lifetime makes it possible to design the reversible and the self-healing polymeric materials at mild temperatures without an external stimulus.

US 2017/327627 A1 discloses malleable, repairable, and reprogrammable shape memory polymers having hindered urea bonds.

The above prior arts all lead to the formation of linear polyurea polymers with dynamic bonds. However, there is requirement of additional reactants such as polyols for the formation of cross-linked three-dimensional polymers, which do not provide uniformity to the structure. Thus, it is an object of the presently claimed invention to provide a polyurea polymer having a uniform three-dimensional network structure that is prepared from polyamines and polyisocyanates without using any additional reactants such as polyols and yet having dynamic bonds.

Another object of the invention is to provide a recyclable three-dimensional network polyurea copolymer.

### SUMMARY OF INVENTION

The object is achieved by reacting an isocyanate mixture (A) having an average NCO functionality of ≥2.10 with at least one secondary amine (B) having at least two secondary amine functionalities.

Accordingly, in a first aspect, the presently claimed invention is directed to a polyurea copolymer obtained by reacting a reaction mixture comprising:

a. an isocyanate mixture (A); and
b. at least one secondary amine of formula (B)

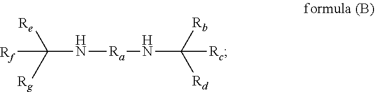

wherein Rₐ is selected from the group consisting of substituted or unsubstituted, linear or branched C₁-C₃₀ alkylene, substituted or unsubstituted, linear or branched 2- to 30-membered heteroalkylene, substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene, substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10.

In a second aspect, the presently claimed invention is directed to a process for preparing a polyurea copolymer comprising at least the steps of:

i) providing an isocyanate mixture (A) which has an average NCO functionality of ≥2.10;
ii) providing at least one secondary amine of formula (B),

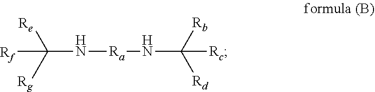

wherein Rₐ, R_{b}, R_{c}, R_{d}, Rₑ, R_{f} and R_{g} are defined as herein below, and
iii) contacting (A) and (B).

In a third aspect, the presently claimed invention is directed to an article comprising a polyurea copolymer.

In fourth aspect, the presently claimed invention is directed to a process for reshaping a polyurea copolymer comprising at least the steps of:

a) applying pressure and heat to the polyurea copolymer as described herein to obtain a heated polyurea copolymer; and
b) shaping the heated polyurea copolymer of step a).

### DETAILED DECEPTION OF INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a polyurea copolymer obtained by reacting:

a. an isocyanate mixture (A); and
b. at least one secondary amine of formula (B)

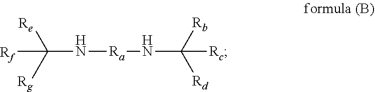

wherein Rₐ is selected from the group consisting of substituted or unsubstituted, linear or branched C₁-C₃₀ alkylene, substituted or unsubstituted, linear or branched 2- to 30-membered heteroalkylene, substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene,
substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10;
more preferably the polyurea copolymer is obtained by reacting:
a. an isocyanate mixture (A); and
b. at least one secondary amine of formula (B)

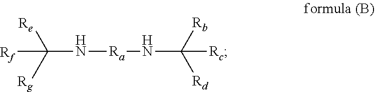

wherein Rₐ is selected from the group consisting of substituted or unsubstituted, linear or branched C₁-C₃₀ alkylene, substituted or unsubstituted, linear or branched C₂-C₃₀ alkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₅-C₃₀ cycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10;
even more preferably the polyurea copolymer is obtained by reacting:
a. an isocyanate mixture (A); and
b. at least one secondary amine of formula (B)

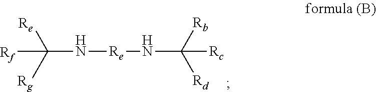

wherein Rₐ is selected from the group consisting of substituted or unsubstituted, linear or branched C₁-C₃₀ alkylene, substituted or unsubstituted, linear or branched C₂-C₃₀ alkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₅-C₃₀ cycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkenylene and substituted or unsubstituted C₂-C₃₀ alkenylene C₆-C₃₀ arylene, and
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10,
the molar ratio of NCO in the isocyanate mixture (A) to —NH— in the at least one secondary amine (B) is in the range of ≥1.0:2.5 to ≤2.5:1.0; and
the polyurea copolymer has a weight average molecular weight Mw in the range of 3000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry;
most preferably the polyurea copolymer is obtained by reacting:
a. an isocyanate mixture (A); and
b. at least one secondary amine of formula (B)

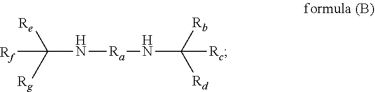

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene and substituted or unsubstituted C₂-C₃₀ alkenylene C₆-C₃₀ arylene, and
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10,
the molar ratio of NCO in the isocyanate mixture (A) to —NH— in the at least one secondary amine (B) is in the range of ≥1.0:2.0 to ≤2.0:1.0; and
the polyurea copolymer has a weight average molecular weight Mw in the range of 5000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry; and
in particular the polyurea copolymer is obtained by reacting:
a. an isocyanate mixture (A); and
b. at least one secondary amine of formula (B)

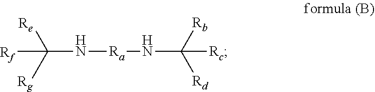

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene and substituted or unsubstituted C₆-C₃₀ arylene C₁-C₃₀ alkylene C₆-C₃₀ arylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl and substituted or unsubstituted C₆-C₃₀ aryl
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N and S as ring member(s); and
wherein the isocyanate mixture (A) has an average NCO functionality of ≥2.10,
the molar ratio of NCO in the isocyanate mixture (A) to —NH— in the at least one secondary amine (B) is in the range of ≥1.0:0.5 to ≤0.5:1.0; and
the polyurea copolymer has a weight average molecular weight Mw in the range of 5000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

For the purposes of the present invention, the term “alkylene” covers acyclic saturated hydrocarbon residues, which may be acyclic saturated hydrocarbon chains, which combine different moieties, as in the case of C₁-C₃₀ alkylene with 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkylene, 1 to 5 (i.e. 1, 2, 3, 4 or 5) C atoms. Representative examples of the alkylene groups include, but are not limited to, —CH₂—CH₂—, —CH₂—CH(CH₃)—, —CH₂—CH(CH₂CH₃)—, —CH₂—CH(n-C₃H₇)—, —CH₂—CH(n-C₄H₉)—, —CH₂—CH(n-C₅H₁₁)—, —CH₂—CH(n-C₆H₁₃)—, —CH₂—CH(n-C₇H₁₅)—, —CH₂—CH(n-C₈H₁₇)—, —CH(CH₃)—CH(CH₃)—, —C(CH₃)₂—, —CH₂—C(CH₃)₂—CH₂—, and —CH₂—[C(CH₃)₂]₂—CH₂—, —(CH₂)₃—, —(CH₂)₄—, —(CH₂)₅—, —(CH₂)₆—, —(CH₂)₈—, —(CH₂)₁₀—, —(CH₂)₇—, —(CH₂)₉—, —(CH₂)₁₁—, —(CH₂)₁₂—, —(CH₂)₁₃—, —(CH₂)₁₄—, —(CH₂)₁₅—, —(CH₂)₁₆—, —(CH₂)₁₇—, —(CH₂)₁₈—, —(CH₂)₁₉—, —(CH₂)₂₀—, —(CH₂)₂₁—, —(CH₂)₂₂—, —(CH₂)₂₃—, —(CH₂)₂₄—, —(CH₂)₂₅—, —(CH₂)₂₆—, —(CH₂)₂₇—, —(CH₂)₂₈—, —(CH₂)₂₉— and —(CH₂)₃₀—.

For the purposes of the present invention, the term “heteroalkylene” refers to an alkylene chain as described above, in which one or more carbon atoms have been replaced with heteroatoms each independently selected from the group consisting of oxygen, sulfur and nitrogen (NH). The heteroalkylene groups can preferably have 1, 2 or 3 heteroatom (s), particularly preferably 1 heteroatom selected from the group consisting of oxygen, sulfur and nitrogen (NH) as chain link(s). The heteroalkylene groups can preferably be 2- to 30-membered, particularly preferably 2- to 12-membered, very particularly preferably 2- or 6-membered. More preferably, ‘0’ is the most preferred heteroatom in “heteroalkylene”. Representative examples of the heteroalkylene groups include, but are not limited to, (—CH₂—O—CH₂-)₁₋₅₀₀, (—CH₂O—CH(CH₃)—)₁₋₅₀₀, —CH₂—O—CH(CH₃)—, —CH₂—O—CH(CH₂CH₃)—, —CH₂—O—CH(n-C₃H₇)—, —CH₂—O—CH(n-C₄H₉)—, —CH₂—O—CH(n-C₅H₁₁)—, —CH₂—O—CH(n-C₆H₁₃)—, —CH₂—O—CH(n-C₇H₁₅)—, —CH₂—O—CH(n-C₈H₁₇)—, —CHO—(CH₃)—CHO—(CH₃)—, —CO—(CH₃)₂—, —CH₂—O—C(CH₃)₂—CH₂—, —CH₂—[O—C(CH₃)₂]₂—CH₂—, —(CH₂)₃—O—CH₂, —(CH₂)₄—O—CH₂, —(CH₂)₅—O—CH₂, —(CH₂)₆—O—CH₂, —(CH₂)₈—OCH₂—, —(CH₂)₁₀—O—CH₂, —(CH₂)₇—O—CH₂, —(CH₂)₉—O—CH₂, —(CH₂)₁₁—O—CH₂, —(CH₂)₁₂—O—CH₂, —(CH₂)₁₃—O—CH₂, —(CH₂)₁₄—O—CH₂, —(CH₂)₁₅—O—CH₂, —(CH₂)₁₆—O—CH₂, —(CH₂)₁₇—O—CH₂, —(CH₂)₁₈—O—CH₂, —(CH₂)₁₉—O—CH₂, —(CH₂)₂₀—O—CH₂, —(CH₂)₂₁—OCH₂, —(CH₂)₂₂—OCH₂, —(CH₂)₂₃—O—CH₂, —(CH₂)₂₄—OCH₂, —(CH₂)₂₅—OCH₂, —(CH₂)₂₆—OCH₂, —(CH₂)₂₇—O—CH₂, —(CH₂)₂₈—O—CH₂, —(CH₂)₂₉—O—CH₂— and —(CH₂)₃₀—O—CH₂, —CH₂—S—CH₂—, —CH₂—NH—CH₂—, —CH₂—NH— and —CH₂—CH₂—NH—CH₂—CH₂—.

The term “alkenylene” includes within the meaning of the present invention, acyclic unsaturated hydrocarbon chains having at least one double bond, preferably 1, 2 or 3 double bonds, and may be branched or linear and unsubstituted or at least monosubstituted with as in the case of C₂-C₃₀ alkenylene 2 to 30 (i.e. 2, 3, 4, 5, 6, 7, 8, 9, 10, 11, 12, 13, 14, 15, 16, 17, 18, 19, 20, 21, 22, 23, 24, 25, 26, 27, 28, 29 or 30) C-atoms, more preferably C₂-C₂₀ alkenylene, most preferably C₂-C₁₀ alkenylene, and in particular C₂-C₆ alkenylene. The representative examples include —CH═CH— and —CH₂—CH═CH—.

The term “heteroalkenylene” refers to an alkenylene chain as described above, in which one or more carbon atoms have been replaced with heteroatoms each independently selected from the group consisting of oxygen, sulfur and nitrogen (NH). The heteroalkenylene groups can preferably have 1, 2 or 3 heteroatom (s), particularly preferably 1 heteroatom selected from the group consisting of oxygen, sulfur and nitrogen (NH) as chain link(s). The heteroalkenylene groups can preferably be 3- to 30-membered, particularly preferably 3- to 12-membered, very particularly preferably 3- or 6-membered. The examples for heteroalkenylene groups are —CH═CH—NH—, —CH═CH—O—, —CH═CH—CH₂—O— and —CH═CH—S—.

In another preferred embodiment, if one or more of the substituents denote an alkylene, alkenylene, heteroalkylene and heteroalkenylene group or comprises such a group, which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated —C₁₋₅alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue are unsubstituted or substituted with 1, 2, 3, 4 or 5 substituents mutually independently selected from the group consisting of F, Cl, Br, I, —OH, —SH, —NO₂, —CN, —O—CH₃, —O—CF₃, and —O—C₂H₅.

In another preferred embodiment, the term “cycloalkylene” covers saturated cyclic hydrocarbon residues. Representative examples of the C₅-C₃₀ cycloalkylene groups include, but are not limited to, cyclopentylene (e.g., cyclopenta-1,3-ylene, cyclopenta-1,2-ylene), cyclohexylene (eg, cyclohexa-1,4-ylene, cyclohexa-1,3-ylene and cyclohexa-1,2-ylene), cycloheptylene, cyclooctylene groups (e.g. 1,5-cyclooctylene). The term “cycloalkylene” also covers a bridged cyclic hydrocarbon group such as a cyclic hydrocarbon group with 2 to 4 rings having 5 to 30 carbon atoms including, but not limited to, norbornylene groups (e.g. 1,4-norbornylene group and 2,5-norbornylene group), and admantylene groups (e.g. 1,5-admantylene group and 2,6-admantylene group).

In another preferred embodiment, the term “heterocycloalkylene”, for the purposes of this application, refers to a cyclic or polycyclic, saturated divalent radical having from 5 to 30 ring members in which carbon atoms are replaced with 1, 2 or 3 heteroatom(s) selected from the group consisting of N, O and S. This term is further exemplified by such groups as 1,5-dioxaoctylene, 4,8-dioxabicyclo[3.3.0]octylene and the like.

In another preferred embodiment, the term “cycloalkenylene” covers a bivalent cycloalkenyl ring structure, i.e., the cycloalkenyl group as defined herein having two single bonds as points of attachment to other groups. For example, the “cycloalkenylene” includes, but is not limited to, cyclopent-1,2-en-3,5-ylene, 3-cyclohexene-1,2-ylene, 2,5-cyclohexadiene-1,4-ylene, cyclohex-1,2-en-3,5-ylene, 2,5-cyclohexadiene-1,4-ylene and cyclohept-1,2-en-3,5-ylene.

In another preferred embodiment, the term “heterocycloalkenylene”, for the purposes of this application, refers to a cyclic or polycyclic, nonaromatic unsaturated divalent radical having from 5 to 30 carbon atoms in which carbon atoms are replaced with 1, 2 or 3 heteroatom(s) selected from N, O and S heteroatom and having 1, 2 or 3 double bond(s).

In another preferred embodiment, if one or more of the substituents denote a cycloalkylene, cycloalkenylene, heterocycloalkylene, and heterocycloalkenylene which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —N H-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated-C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S— phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In another preferred embodiment, the term “arylene”, refers to a closed aromatic divalent ring or ring system such as phenylene, naphthylene, biphenylene, fluorenylene, and indenyl.

In another preferred embodiment, the term “heteroarylene”, refers to a closed aromatic divalent ring or ring system having at least one heteroatom selected from nitrogen, oxygen and sulfur. Suitable heteroarylene groups include furylene, thienylene, pyridylene, quinolinylene, isoquinolinylene, indolylene, isoindolylene, triazolylene, pyrrolylene, tetrazolylene, imidazolylene, pyrazolylene, oxazolylene, thiazolylene, benzofuranylene, benzothiophenylene, carbazolylene, benzoxazolylene, pyrimidinylene, benzimidazolylene, quinoxalinylene, benzothiazolylene, naphthyridinylene, isoxazolylene, isothiazolylene, purinylene, quinazolinylene, pyrazinylene, 1-oxidopyridylene, pyridazinylene, triazinylene, tetrazinylene, oxadiazolylene and thiadiazolylene.

In another preferred embodiment, if one or more of the substituents denote an arylene and a heteroarylene which is mono- or polysubstituted, this is preferably substituted with 1, 2, 3 or 4, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —N H-phenyl, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated-C₁₋₅alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. Most preferably alkylene, alkenylene, heteroalkylene and heteroalkenylene groups are unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

For the purposes of the present invention, the term “alkyl” covers acyclic saturated hydrocarbon residues, which may be branched or linear and unsubstituted or at least monosubstituted with, as in the case of C₁-C₃₀ alkyl, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkyl, 1 to 5 (i.e. 1, 2, 3, 4 or 5) C atoms. If one or more of the substituents denote an alkyl residue or comprise an alkyl residue which is mono- or polysubstituted, this is preferably substituted with 1, 2, 3, 4 or 5, particularly preferably with 1, 2 or 3, substituents mutually independently selected from the group consisting of F, Cl, Br, I, —NO₂, —CN, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In a preferred embodiment, the unsubstituted linear C₁-C₃₀ alkyl is preferably selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; even more preferably selected from the group consisting of methyl, ethyl, propyl, butyl, pentyl, hexyl, heptyl, octyl, nonyl, decyl, undecyl, dodecyl, tridecyl, tetradecyl and pentadecyl; most preferably selected from the group consisting of methyl, ethyl, propyl, butyl, pentyl, hexyl, heptyl, octyl, nonyl, decyl, undecyl and dodecyl; and in particular preferably selected from the group consisting of methyl, ethyl, propyl, butyl, pentyl, hexyl, heptyl, octyl, nonyl and decyl.

In a preferred embodiment, the unsubstituted branched C₁-C₃₀ alkyl is preferably selected from the group consisting of isopropyl, iso-butyl, neo-pentyl, 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl and iso-eicosyl, more preferably selected from the group consisting of 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl, iso-dodecyl, iso-tetradecyl, iso-hexadecyl, iso-octadecyl, iso-eicosyl, 2-methyltricosyl, 2-ethyldocosyl, 3-ethylhenicosyl, 3-ethylicosyl, 4-propylhenicosyl, propylnonadecyl, 6-butyldodecyl and 5-ethylundecyl. The polysubstituted alkyl residues are understood to be those alkyl residues which are either poly-, preferably di- or trisubstituted, either on different or on the same C atoms, for example trisubstituted on the same C atom as in the case of —CF₃, or at different locations as in the case of —(CHCl)—(CH₂F). Polysubstitution may proceed with identical or different substituents. Examples which may be mentioned of suitable substituted alkyl residues are —CF₃, —CF₂H, —CFH₂, —(CH₂)—OH, —(CH₂)—NH₂, —(CH₂)—CN, —(CH₂)—(CF₃), —(CH₂)—(CHF₂), —(CH₂)—(CH₂F), —(CH₂)—(CH₂)—O—CH₃, —(CH₂)—(CH₂)—NH₂, —(CH₂)—(CH₂)—CN, —(CF₂)—(CF₃), —(CH₂)—(CH₂)—(CF₃), and —(CH₂)—(CH₂)—(CH₂)—O—CH₃.

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of F, Cl, Br, I, —NO₂, —CN, —SH, —NH₂, —N(C₁₋₅-alkyl)₂, —N(C₁₋₅-alkyl)(phenyl), —N(C₁₋₅-alkyl)(CH₂-phenyl), —N(C₁₋₅-alkyl)(CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are preferably unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In another preferred embodiment, the substituted, linear or branched, C₁-C₃₀ alkyl refers to a branched or linear saturated hydrocarbon group having C₁-C₃₀ carbon atoms substituted with functional groups selected from the group consisting of alkoxy, C(═O)R, CN and SR, preferably selected from the group consisting of 1-methoxy methyl, 1-methoxy methyl, 1-methoxy ethyl, 1-methoxy propyl, 1-methoxy butyl, 1-methoxy pentyl, 1-methoxy hexyl, 1-methoxy heptyl, 1-methoxy octyl, 1-methoxy nonyl, decyl, 1-methoxy undecyl, 1-methoxy dodecyl, 1-methoxy tridecyl, 1-methoxy tetradecyl, 1-methoxy pentadecyl, 1-methoxy hexadecyl, 1-methoxy heptadecyl, 1-methoxy octadecyl, 1-methoxy nonadecyl, 1-methoxy eicosyl, 1-methoxy henicosyl, 1-methoxy docosyl, 1-methoxy tricosyl, 1-methoxy tetracosyl, 2-methoxy propyl, 2-methoxy butyl, 2-methoxy pentyl, 2-methoxy hexyl, 2-methoxy heptyl, 2-methoxy octyl, 2-methoxy nonyl, decyl, 2-methoxy undecyl, 2-methoxy dodecyl, 2-methoxy tridecyl, 2-methoxy tetradecyl, 2-methoxy pentadecyl, 2-methoxy hexadecyl, 2-methoxy heptadecyl, 2-methoxy octadecyl, 2-methoxy nonadecyl, 2-methoxy eicosyl, 2-methoxy henicosyl, 2-methoxy docosyl, 2-methoxy tricosyl, 2-methoxy tetracosyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, decyl, 1-acetoxy undecyl, 1-acetoxy dodecyl, 1-acetoxy tridecyl, 1-acetoxy tetradecyl, 1-acetoxy pentadecyl, 1-acetoxy hexadecyl, 1-acetoxy heptadecyl, 1-acetoxy octadecyl, 1-acetoxy nonadecyl, 1-acetoxy eicosyl, 1-acetoxy henicosyl, 1-acetoxy docosyl, 1-acetoxy tricosyl, 1-acetoxy tetracosyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, decyl, 1-cyano undecyl, 1-cyano dodecyl, 1-cyano tridecyl, 1-cyano tetradecyl, 1-cyano pentadecyl, 1-cyano hexadecyl, 1-cyano heptadecyl, 1-cyano octadecyl, 1-cyano nonadecyl, 1-cyano eicosyl, 1-cyano henicosyl, 1-cyano docosyl, 1-cyano tricosyl, 1-cyano tetracosyl, 2-cyano propyl, 2-cyano butyl, 2-cyano pentyl, 2-cyano hexyl, 2-cyano heptyl, 2-cyano octyl, 2-cyano nonyl, decyl, 2-cyano undecyl, 2-cyano dodecyl, 2-cyano tridecyl, 2-cyano tetradecyl, 2-cyano pentadecyl, 2-cyano hexadecyl, 2-cyano heptadecyl, 2-cyano octadecyl, 2-cyano nonadecyl, 2-cyano eicosyl, 2-cyano henicosyl, 2-cyano docosyl, 2-cyano tricosyl, 2-cyano tetracosyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, decyl, 1-thioyl undecyl, 1-thioyl dodecyl, 1-thioyl tridecyl, 1-thioyl tetradecyl, 1-thioyl pentadecyl, 1-thioyl hexadecyl, 1-thioyl heptadecyl, 1-thioyl octadecyl, 1-thioyl nonadecyl, 1-thioyl eicosyl, 1-thioyl henicosyl, 1-thioyl docosyl, 1-thioyl tricosyl and 1-thioyl tetracosyl.

In a preferred embodiment, the term alkenyl denotes unsubstituted, linear C₂-C₃₀ alkenyl which is preferably selected from the group consisting of 1-propenyl, 1-butenyl, 1-pentenyl, 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, more preferably selected from 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, 20-henicosenyl, 2-docosenyl, 6-tricosenyl and 2-tetracosenyl.

In a preferred embodiment, the unsubstituted branched C₂-C₃₀ alkenyl is selected from the group consisting of isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, iso-nonenyl, iso-decenyl, iso-dodecenyl, iso-tetradecenyl, iso-hexadecenyl, iso-octadecenyl, iso-eicosenyl, 2-methyl tricosenyl, 2-ethyl docosenyl, 3-ethylhenicosenyl, 3-ethyl icosenyl, 4-propylhenicosenyl, 4-propylnonadecenyl, 6-butyldodecenyl, 5-ethylundedcenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or 2-methyl-1,3,5hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl, and 1,4,6,9,11-dodecapentaenyl.

In a preferred embodiment, the substituted, linear or branched, C₂-C₃₀ alkenyl refers to a branched or an linear unsaturated hydrocarbon group having C₂-C₃₀ carbon atoms substituted with functional groups selected from alkoxy, C(═O)R, CN and SR; wherein R is hydrogen, substituted or unsubstituted, linear or branched C₁-C₃₀ alkyl, substituted or unsubstituted, linear or branched C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted C₇-C₃₀ arylalkyl.

In a preferred embodiment, the term alkenyl refers to a branched or an linear unsaturated hydrocarbon group having C₂-C₃₀ carbon atoms substituted with functional groups selected from, alkoxy, C(═O)R, CN and SR; preferably selected from the group consisting of 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 1-methoxy tridec-5-enyl, 3-methoxy tetradic-5-enyl, 3-methoxy pentade-12-encyl, 10-methoxy hexadec-15-enyl, 12-methoxy heptadic-16-enyl, 1-methoxy octadec-3-enyl, 1-methoxy nonadec-2-enyl, 1-methoxy eicos-20-enyl, 1-methoxy henicos-2-enyl, 1-methoxy docos-4-enyl, 1-methoxy tricos-22-enyl, 1-methoxy tetracos-23-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 2-methoxy tridec-12-enyl, 2-methoxy tetradic-10-enyl, 2-methoxy pentadec-14-enyl, 2-methoxy hexadec-1-enyl, 2-methoxy heptadic-1-enyl, 2-methoxy octadic-12-enyl, 2-methoxy nonadec-10-enyl, 2-methoxy eicos-18-enyl, 2-methoxy henicos-2-enyl, 2-methoxy docos-3-enyl, 20-methoxy tricos-2-enyl, 21-methoxy tetracos-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-acetoxy tridec-12-enyl, 10-acetoxy tetradec-2-enyl, 15-acetoxy pentadec-2-enyl, 10-acetoxy hexadec-2-enyl, 11-acetoxy heptadec-1-enyl, 13-acetoxy octadec-2-enyl, 1-acetoxy nonadec-14-enyl, 20-acetoxy eicos-19-enyl, 1-acetoxy henicos-2-enyl, 1-acetoxy docos-10-enyl, 1-acetoxy tricos-22-enyl, 1-acetoxy tetracos-23-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 10-cyano tridec-12-enyl, 1-cyano tetradec-3-enyl, 1-cyano pentadec-14-enyl, 1-cyano hexadec-15-enyl, 1-cyano heptadec-2-enyl, 1-cyano octadec-3-enyl, 1-cyano nonadec-18-enyl, 1-cyano eicos-10-enyl, 1-cyano henicos-20-enyl, 15-cyano docos-3-enyl, 1-cyano tricos-20-enyl, 1-cyano tetracos-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 2-cyano tridec-12-enyl, 2-cyano tetradec-10-enyl, 2-cyano pentadec-3-enyl, 2-cyano hexadec-2-enyl, 2-cyano heptadec-1-enyl, 2-cyano octadec-12-enyl, 2-cyano nonadec-15-enyl, 2-cyano eicos-1-enyl, 2-cyano henicos-5-enyl, 2-cyano docos-20-enyl, 2-cyano tricos-22-enyl, 2-cyano tetracos-20-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl, 1-thionyl dodec-11-enyl, 1-thionyl tridec-2-enyl, 1-thionyl tetradec-4-enyl, 1-thionyl pentadec-5-enyl, 1-thionyl hexadec-3-enyl, 1-thionyl heptadec-2-enyl, 1-thionyl octadec-3-enyl, 1-thionyl nonadec-15-enyl, 1-thionyl eicos-18-enyl, 1-thionyl henicos-20-enyl, 1-thionyl docos-21-enyl, 1-thionyl tricos-20-enyl and 1-thionyl tetracos-22-enyl.

In a preferred embodiment, the term “heteroalkyl” refers to an alkyl group, in which one or more carbon atoms have in each case been replaced by a heteroatom mutually independently selected from the group consisting of oxygen, sulfur and nitrogen (NH). Heteroalkyl residues preferably comprise 1, 2 or 3 heteroatom(s) mutually independently selected from the group consisting of oxygen, sulfur and nitrogen (NH) as chain link(s). Heteroalkyl residues may preferably be 2- to 12-membered, particularly preferably 2- to 6-membered.

In a preferred embodiment, the term “heteroalkenyl” refers to an alkenyl group, in which one or more carbon atoms have in each case been replaced by a heteroatom mutually independently selected from the group consisting of oxygen, sulfur and nitrogen (NH). Heteroalkenyl residues preferably comprise 1, 2 or 3 heteroatom(s) mutually independently selected from the group consisting of oxygen, sulfur and nitrogen (NH) as chain link(s). Heteroalkenyl residues may preferably be 3- to 12-membered, particularly preferably 3- to 6-membered.

In a preferred embodiment, the term “cycloalkyl” refers to a monocyclic and bicyclic saturated cycloaliphatic radical having 5 to 30 carbon atoms. Representative examples of unsubstituted or branched C₅-C₃₀ monocyclic and bicyclic cycloalkyl include, but are not limited to, cyclopentyl, cyclohexyl, cycloheptyl, cyclooctyl, bicyclo[2.2.1]heptyl, and bicyclo[3.1.1]heptyl.

In another preferred embodiment, the C₅-C₃₀ monocyclic and bicyclic cycloalkyl can be further branched with one or more equal or different alkyl groups such as methyl, ethyl, n-propyl, iso-propyl, n-butyl, iso-butyl, n-pentyl, iso-pentyl, neo-pentyl etc. The representative examples of branched C₃-C₁₀ monocyclic and bicyclic cycloalkyl include, but are not limited to, methyl cyclohexyl and dimethyl cyclohexyl.

In a preferred embodiment, the term “cycloalkenyl” refers to a monocyclic and bicyclic unsaturated cycloaliphatic radical having 5 to 30 carbon atoms, which comprises one or more double bonds. Representative examples of C₅-C₃₀ cycloalkenyl include, but are not limited to, cyclopentenyl, cyclohexenyl, cycloheptenyl, cyclooctenyl, cyclononenyl or cyclodecenyl. These radicals can be branched with one or more equal or different alkyl radical, preferably with methyl, ethyl, n-propyl or iso-propyl. The representative examples of branched C₅-C₃₀ monocyclic and bicyclic cycloalkenyl include, but are not limited to, methyl cyclohexenyl and dimethyl cyclohexenyl.

In a preferred embodiment, the term “heterocycloalkyl” means a non-aromatic monocyclic or polycyclic ring comprising 5 to 30 ring members in which at least one carbon atom as a ring member is replaced with at least one heteroatom selected from O, S, and N. Examples of heterocycloalkyl groups include aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl and pyranyl.

In a preferred embodiment, the term “heterocycloalkenyl” means a non-aromatic unsaturated monocyclic or polycyclic ring comprising 5 to 30 ring members in which at least carbon atom as ring member is replaced with at least one heteroatom selected from O, S, and N and having at least one double bond. The example include, but are not limited to, (2,3)-dihydrofuranyl, (2,3)-dihydrothienyl, (2,3)-dihydropyrrolyl, (2,5)-dihydropyrrolyl, (2,5)-dihydropyrrolyl, (2,3)-dihydroisoxazolyl, (1,4)-dihydropyridin-1-yl, di-hydropyranyl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 4,5-dihydropyrazol-2-yl, 4,5-dihydropyrazol-3-yl, 4,5-dihydropyrazol-4-yl, 4,5-dihydropyrazol-5-yl, 2,5-dihydrothienyl and (1,2,3,4)-tetrahydropyridin-1-yl.

In another preferred embodiment, if one or more of the substituents denote a heteroalkyl, heteroalkenyl, cycloalkyl, cycloalkenyl, heterocycloalkyl and heterocycloalkenyl which is mono- or polysubstituted, this group is preferably substituted with 1, 2, 3, 4 or 5, particularly preferably with 1, 2 or 3, substituents mutually independently selected from the group consisting of F, Cl, Br, I, —CN, —NO₂, —OH, —SH, —NH₂, oxo (═O), thioxo (═S), —C(═O)—OH, C₁₋₅ alkyl, —C₂₋₅ alkenyl, —C₂₋₅ alkynyl, —C≡C—Si(CH₃)₃, —C≡C—Si(C₂H₅)₃, —(CH₂)—O—C₁₋₅-alkyl, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)(C₁₋₅-alkyl), —C(═O)—O—C₁₋₅-alkyl, —C(═O)—H, —C(═O) C₁₋₅-alkyl, —CH₂—O—C(═O)-phenyl, —O—C(═O)-phenyl, —NH—S(═O)₂—C₁₋₅-alkyl, —NH—C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiadiazolyl, thiophenyl (thienyl) and benzyl, wherein the above-stated C₁₋₅ alkyl residues are in each case linear or branched and the cyclic substituents or the cyclic residues of these substituents themselves are in each case unsubstituted or substituted with 1, 2, 3, 4 or 5, preferably with 1, 2, 3 or 4, substituents mutually independently selected from the group consisting of F, Cl, Br, I, —CN, CF₃, —OH, —NH₂, —O—CF₃, —SH, —O—C₁₋₅-alkyl, —O-phenyl, —O—CH₂-phenyl, —(CH₂)—O—C₁₋₅-alkyl, —S—C₁₋₅-alkyl, —S-phenyl, —S—CH₂-phenyl, —C₁₋₅alkyl, —C₂-5 alkenyl, —C₂₋₅alkynyl, —C≡C—Si(CH₃)₃, —C≡C—Si(C₂H₅)₃, —C(═O)—O—C₁₋₅-alkyl and —C(═O)—CF₃.

In a preferred embodiment, the term “aryl” refers to an aromatic compounds that may have more than one aromatic ring. The representative examples for substituted and unsubstituted C₆-C₃₀ aryl include phenyl, naphthyl, anthracenyl, tetraphenyl, phenalenyl and phenanthrenyl.

In a preferred embodiment, the term “heteroaryl” means a monocyclic or polycyclic, preferably a mono-, bi- or tricyclic aromatic hydrocarbon residue with preferably 5, 6, 7, 8, 9, 10, 11, 12, 13, 14, 15, 16, 17, 18, 19, 20, 21, 22, 23, 24, 25, 26, 27, 28, 29 or 30 ring members, particularly preferably with 5, 6, 9, 10, 13 or 14 ring atoms, very particularly preferably with 5 or 6 ring members, in which one or more carbon atoms as ring members have been replaced with heteroatoms each independently selected from the group consisting of oxygen, sulfur and nitrogen (NH). Heteroaryl residues may preferably comprise 1, 2, 3, 4 or 5, particularly preferably 1, 2 or 3, heteroatom(s) mutually independently selected from the group consisting of oxygen, sulfur and nitrogen (NH) as ring member(s) A heteroaryl residue is unsubstituted or monosubstituted or identically or differently polysubstituted. The examples of suitable heteroaryl residues which may be mentioned are thienyl, furyl, pyrrolyl, pyrazolyl, pyrazinyl, pyranyl, triazolyl, pyridinyl, imidazolyl, indolyl, isoindolyl, benzo[b]furanyl, benzo[b]thiophenyl, benzo[d]thiazolyl, benzodiazolyl, benzotriazolyl, benzoxazolyl, benzisoxazolyl, thiazolyl, thiadiazolyl, oxazolyl, oxadiazolyl, isoxazolyl, pyridazinyl, pyrimidinyl, indazolyl, quinoxalinyl, quinazolinyl, quinolinyl, naphthridinyl and isoquinolinyl.

For the purposes of the present invention aryl or heteroaryl residues may be fused (anellated) with a mono- or bicyclic ring system. Examples which may be mentioned of aryl residues which are fused with a mono- or bicyclic ring system are (1,2,3,4)-tetrahydroquinolinyl, (1,2,3,4)-tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl and (3,4)-dihydro-2H-benzo[1.4]oxazinyl.

In another preferred embodiment, the “arylalkyl” refers to an aryl ring attached to an alkyl chain. The representative examples for the arylalkyl include, but are not limited to, 1-phenylmethyl, 1-phenylethyl, 1-phenylpropyl, 1-phenylbutyl, 1-methyl-1-phenyl-propyl, 3-phenylpropyl, 4-phenylbutyl, 3-phenylbutyl and 2-methyl-3-phenyl-propyl.

In another preferred embodiment, if one or more of the substituents denote an aryl, heteroaryl or arylalkyl residue or comprise an aryl or heteroaryl residue which is mono- or polysubstituted, this may preferably be substituted with 1, 2, 3, 4 or 5, particularly preferably with 1, 2 or 3, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅ alkyl, —S-phenyl, —S—CH₂-phenyl, —O—₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)₂, —C(═O)—O—C₁₋₅-alkyl, —C(═O)—H; —C(═O)—C₁₋₅-alkyl, —CH₂—O—C(═O)-phenyl, —O—C(═O)-phenyl, —NH—S(═O)₂—C₁₋₅-alkyl, NH C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiazolyl, thiadiazolyl, thiophenyl (thienyl), benzyl and phenethyl, wherein the above-stated C₁₋₅ alkyl residues are in each case linear or branched and the cyclic substituents or the cyclic residues of these substituents themselves are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —OCF₃, —OCHF₂, —O—CH₂F, —C(═O)—CF₃, —S—CF₃, —S—CHF₂ and —S—CH₂F; most preferably, the substituents are in each case mutually independently selected from the group consisting of F, Cl, Br, I, —CN, —NO₂, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —SH, —NH₂, —C(═O)—OH, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, pyrazolyl, phenyl, —N(CH₃)₂, —N(C₂H₅)₂, —NH—CHs, —NH—C₂H₅, —CH₂—O—C(═O)-phenyl, —NH—S(═O)₂—CH₃, —C(═O)—O—CH₃, —C(═O) 0 C₂H₅, C(═O) 0-C(CH₃)₃, —C(═O)—H, —C(═O) CH₃, —C(═O)—C₂H₅, —NH—C(═O)—CH₃, —NH—C(═O)—C₂H₅, —O—C(═O)-phenyl, —C(═O)—NH₂, —C(═O)—NH—CH₃, —C(═O)—N(CH₃)₂, phenyl, furyl (furanyl), thiadiazolyl, thiophenyl (thienyl) and benzyl, wherein the cyclic substituents or the cyclic residues of these substituents themselves are in each case unsubstituted or substituted with 1, 2, 3, 4, or 5, preferably with 1, 2, 3 or 4, substituents mutually independently selected from the group consisting of F, Cl, Br, I, —CN, —NO₂, —SH, —NH₂, —C(═O)—OH, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—O₂H₅, —S—CH₃, —S—C₂H₅, —S(═O)—CH₃, —S(═O)₂—CH₃, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂ and —S—CH₂F.

In another preferred embodiment, a substituted aryl residue may be selected from the group consisting of 2-methylphenyl, 3-methylphenyl, 4-methylphenyl, 2-fluorophenyl, 3-fluorophenyl, 4-fluorophenyl, 2-cyanophenyl, 3-cyanophenyl, 4-cyanophenyl, 2-aminophenyl, 3-aminophenyl, 4-aminophenyl, 2-dimethylaminophenyl, 3-dimethylaminophenyl, 4-dimethylaminophenyl, 2-methylaminophenyl, 3-methylaminophenyl, 4-methylaminophenyl, 2-acetylphenyl, 3-acetylphenyl, 4-acetylphenyl, 2-methylsulfinylphenyl, 3-methylsulfinylphenyl, 4-methylsulfinylphenyl, 2-methylsulfonylphenyl, 3-methylsulfonylphenyl, 4-methylsulfonylphenyl, 2-methoxyphenyl, 3-methoxyphenyl, 4-methoxyphenyl, 2-chlorophenyl, 3-chlorophenyl, 4-chlorophenyl, 2-ethoxyphenyl, 3-ethoxyphenyl, 4-ethoxyphenyl, 2-trifluoromethylphenyl, 3-trifluoromethylphenyl, 4-trifluoromethylphenyl, 2-difluoromethylphenyl, 3-difluoromethylphenyl, 4-difluoromethylphenyl, 2-fluoromethylphenyl, 3-fluoromethylphenyl, 4-fluoromethylphenyl, 2-nitrophenyl, 3-nitrophenyl, 4-nitrophenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-tert.-butylphenyl, 3-tert.-butylphenyl, 4-tert.-butylphenyl, 2-carboxyphenyl, 3-carboxyphenyl, 4-carboxyphenyl, 2-ethenylphenyl, 3-ethenylphenyl, 4-ethenylphenyl, 2-ethynylphenyl, 3-ethynylphenyl, 4-ethynylphenyl, 2-allylphenyl, 3-allylphenyl, 4-allylphenyl, 2-trimethylsilanylethynylphenyl, 3-trimethylsilanylethynylphenyl, 4-trimethylsilanylethynylphenyl, 2-formylphenyl, 3-formylphenyl, 4-formylphenyl, 2-acetaminophenyl, 3-acetaminophenyl, 4-acetaminophenyl, 2-dimethylaminocarbonylphenyl, 3-dimethylaminocarbonylphenyl, 4-dimethylaminocarbonylphenyl, 2-methoxymethylphenyl, 3-methoxymethylphenyl, 4-methoxymethylphenyl, 2-ethoxymethylphenyl, 3-ethoxymethylphenyl, 4-ethoxymethylphenyl, 2-aminocarbonylphenyl, 3-aminocarbonylphenyl, 4-aminocarbonylphenyl, 2-methylaminocarbonylphenyl, 3-methylaminocarbonylphenyl, 4-methylaminocarbonylphenyl, 2-carboxymethyl ester phenyl, 3-carboxymethyl ester phenyl, 4-carboxymethyl ester phenyl, 2-carboxyethyl ester phenyl, 3-carboxyethyl ester phenyl, 4-carboxyethyl ester phenyl, 2-carboxy-tert.-butyl ester phenyl, 3-carboxy-tert.-butyl ester phenyl, 4-carboxy-tert.-butyl ester phenyl, 2-methylmercaptophenyl, 3-methylmercaptophenyl, 4-methylmercaptophenyl, 2-ethylmercaptophenyl, 3-ethylmercaptophenyl, 4-ethylmercaptophenyl, 2-biphenyl, 3-biphenyl, 4-biphenyl, 2-bromophenyl, 3-bromophenyl, 4-bromophenyl, 2-iodophenyl, 3-iodophenyl, 4-iodophenyl, 2-trifluoromethoxyphenyl, 3-trifluoromethoxyphenyl, 4-trifluoromethoxyphenyl, 2-fluoro-3-trifluoromethylphenyl, 2-fluoro-4-methylphenyl, (2,3)-difluorophenyl, (2,3)-dimethylphenyl, (2,3)-dichlorophenyl, 3-fluoro-2-trifluoro-methylphenyl, (2,4)-dichlorophenyl, (2,4)-difluorophenyl, 4-fluoro-2-trifluoromethylphenyl, (2,4)-dimethoxyphenyl, 2-chloro-4-fluorophenyl, 2-chloro-4-nitrophenyl, 2-chloro-4-methylphenyl, 2-chloro-5-trifluoromethylphenyl, 2-chloro-5-methoxyphenyl, 2-bromo-5-trifluoromethylphenyl, 2-bromo-5-methoxyphenyl, (2,4)-dibromophenyl, (2,4)-dimethylphenyl, 2-fluoro-4-trifluoromethylphenyl, (2,5)-difluorophenyl, 2-fluoro-5-trifluoro-methylphenyl, 5-fluoro-2-trifluoromethylphenyl, 5-chloro-2-trifluoromethylphenyl, 5-bromo-2-trifluoromethylphenyl, (2,5)-dimethoxyphenyl, (2,5)-bis-trifluoromethylphenyl, (2,5)-dichlorophenyl, (2,5)-dibromophenyl, 2-methoxy-5-nitrophenyl, 2-fluoro-6-trifluoro-methylphenyl, (2,6)-dimethoxyphenyl, (2,6)-dimethylphenyl, (2,6)-dichlorophenyl, 2-chloro-6-fluorophenyl, 2-bromo-6-chlorophenyl, 2-bromo-6-fluorophenyl, (2,6)-difluorophenyl, (2,6)-difluoro-3-methylphenyl, (2,6)-dibromophenyl, (2,6)-dichlorophenyl, 3-chloro-2-fluorophenyl, 3-chloro-5-methylphenyl, (3,4)-dichlorophenyl, (3,4)-dimethylphenyl, 3-methyl-4-methoxyphenyl, 4-chloro-3-nitrophenyl, (3,4)-dimethoxyphenyl, 4-fluoro-3-trifluoromethylphenyl, 3-fluoro-4-trifluoromethylphenyl, (3,4)-difluorophenyl, 3-cyano-4-fluorophenyl, 3-cyano-4-methylphenyl, 3-cyano-4-methoxyphenyl, 3-bromo-4-fluorophenyl, 3-bromo-4-methylphenyl, 3-bromo-4-methoxyphenyl, 4-chloro-2-fluorophenyl, 4-chloro-3-trifluoromethyl, 4-bromo-3-methylphenyl, 4-bromo-5-methylphenyl, 3-chloro-4-fluorophenyl, 4-fluoro-3-nitrophenyl, 4-bromo-3-nitrophenyl, (3,4)-dibromophenyl, 4-chloro-3-methylphenyl, 4-bromo-3-methylphenyl, 4-fluoro-3-methylphenyl, 3-fluoro-4-methylphenyl, 3-fluoro-5-methylphenyl, 2-fluoro-3-methylphenyl, 4-methyl-3-nitrophenyl, (3,5)-dimethoxyphenyl, (3,5)-dimethylphenyl, (3,5)-bis-trifluoromethylphenyl, (3,5)-difluorophenyl, (3,5)-dinitrophenyl, (3,5)-dichlorophenyl, 3-fluoro-5-trifluoromethylphenyl, 5-fluoro-3-trifluoro-methylphenyl, (3,5)-dibromophenyl, 5-chloro-4-fluorophenyl, 5-chloro-4-fluorophenyl, 5-bromo-4-methylphenyl, (2,3,4)-trifluorophenyl, (2,3,4)-trichlorophenyl, (2,3,6)-trifluorophenyl, 5-chloro-2-methoxyphenyl, (2,3)-difluoro-4-methyl, (2,4,5)-trifluorophenyl, (2,4,5)-trichlorophenyl, (2,4)-dichloro-5-fluorophenyl, (2,4,6)-trichlorophenyl, (2,4,6)-trimethylphenyl, (2,4,6)-trifluorophenyl, (2,4,6)-trimethoxyphenyl, (3,4,5)-trimethoxyphenyl, (2,3,4,5)-tetrafluorophenyl, 4-methoxy-(2,3,6)-trimethylphenyl, 4-methoxy-(2,3,6)-trimethylphenyl, 4-chloro-2,5-dimethylphenyl, 2-chloro-6-fluoro-3-methylphenyl, 6-chloro-2-fluoro-3-methyl, (2,4,6)-trimethylphenyl and (2,3,4,5,6)-pentafluorophenyl.

In another preferred embodiment, a substituted heteroaryl residue may be selected from the group consisting of 3-methylpyrid-2-yl, 4-methylpyrid-2-yl, 5-methylpyrid-2-yl, 6-methylpyrid-2-yl, 2-methylpyrid-3-yl, 4-methylpyrid-3-yl, 5-methylpyrid-3-yl, 6-methylpyrid-3-yl, 2-methylpyrid-4-yl, 3-methylpyrid-4-yl, 3-fluoropyrid-2-yl, 4-fluoropyrid-2-yl, 5-fluoropyrid-2-yl, 6-fluoropyrid-2-yl, 3-chloropyrid-2-yl, 4-chloropyrid-2-yl, 5-chloropyrid-2-yl, 6-chloropyrid-2-yl, 3-trifluoromethylpyrid-2-yl, 4-trifluoromethylpyrid-2-yl, 5-trifluoromethylpyrid-2-yl, 6-trifluoromethylpyrid-2-yl, 3-methoxypyrid-2-yl, 4-methoxypyrid-2-yl, 5-methoxypyrid-2-yl, 6-methoxypyrid-2-yl, 4-methylthiazol-2-yl, 5-methylthiazol-2-yl, 4-trifluoromethylthiazol-2-yl, 5-trifluoromethylthiazol-2-yl, 4-chlorothiazol-2-yl, 5-chlorothiazol-2-yl, 4-bromothiazol-2-yl, 5-bromothiazol-2-yl, 4-fluorothiazol-2-yl, 5-fluorothiazol-2-yl, 4-cyanothiazol-2-yl, 5-cyanothiazol-2-yl, 4-methoxythiazol-2-yl, 5-methoxythiazol-2-yl, 4-methyloxazol-2-yl, 5-methyloxazol-2-yl, 4-trifluoromethyloxazol-2-yl, 5-trifluoromethyloxazol-2-yl, 4-chlorooxazol-2-yl, 5-chlorooxazol-2-yl, 4-bromooxazol-2-yl, 5-bromooxazol-2-yl, 4-fluorooxazol-2-yl, 5-fluorooxazol-2-yl, 4-cyanooxazol-2-yl, 5-cyanooxazol-2-yl, 4-methoxyoxazol-2-yl, 5-methoxyoxazol-2-yl, 2-methyl-(1,2,4)-thiadiazol-5-yl, 2-trifluoromethyl-(1,2,4)-thiadiazolyl-5-yl, 2-chloro-(1,2,4)-thiadiazol-5-yl, 2-fluoro-(1,2,4)-thiadiazol-5-yl, 2-methoxy-(1,2,4)-thiadiazol-5-yl, 2-cyano-(1,2,4)-thiadiazol-5-yl, 2-methyl-(1,2,4)-oxadiazol-5-yl, 2-trifluoromethyl-(1,2,4)-oxadiazol-5-yl, 2-chloro-(1,2,4)-oxadiazol-5-yl, 2-fluoro-(1,2,4)-oxadiazol-5-yl, 2-methoxy-(1,2,4)-oxadiazol-5-yl and 2-cyano-(1,2,4)-oxadiazol-5-yl.

In another preferred embodiment, the isocyanate mixture (A) has an average NCO functionality in the range of ≥2.10 to 6.0; more preferably the isocyanate mixture (A) has an average NCO functionality in the range of ≥2.10 to 5.0; even more preferably the isocyanate mixture (A) has an average NCO functionality in the range of ≥2.10 to 4.5; and most preferably the isocyanate mixture (A) has an average NCO functionality in the range of ≥2.10 to 4.0; and in particular the isocyanate mixture (A) has an average NCO functionality in the range of ≥2.10 to 3.0.

In another preferred embodiment, Rₐ is selected from the group consisting of substituted or unsubstituted, linear or branched C₁-C₃₀ alkylene, substituted or unsubstituted C₅-C₃₀ cycloalkylene, substituted or unsubstituted C₁-C₃₀ alkylene C₅-C₃₀ cycloalkylene and substituted or unsubstituted C₆-C₃₀ arylene C₁-C₃₀ alkylene C₆-C₃₀ arylene; more preferably Rₐ is selected from the group consisting of substituted or unsubstituted, linear or branched C₁-C₂₀ alkylene, substituted or unsubstituted C₅-C₂₀ cycloalkylene, substituted or unsubstituted C₁-C₂₀ alkylene C₅-C₂₀ cycloalkylene and substituted or unsubstituted C₆-C₂₀ arylene C₁-C₂₀ alkylene C₆-C₂₀ arylene; even more preferably Rₐ is selected from the group consisting of substituted or unsubstituted, linear or branched C₁-C₁₀ alkylene, substituted or unsubstituted C₅-C₁₀ cycloalkylene, substituted or unsubstituted C₁-C₁₀ alkylene C₅-C₁₀ cycloalkylene and substituted or unsubstituted C₆-C₁₀ arylene C₁-C₁₀ alkylene C₆-C₁₀ arylene; most preferably Rₐ is selected from the group consisting of substituted or unsubstituted, linear or branched C₁-C₁₀ alkylene, substituted or unsubstituted C₅-C₅ cycloalkylene, substituted or unsubstituted C₁-C₈ alkylene C₅-C₅ cycloalkylene and substituted or unsubstituted C₆-C₅ arylene C₁-C₈ alkylene C₆-C₅ arylene; and in particular Rₐ is selected from the group consisting of substituted or unsubstituted, linear or branched C₁-C₁₀ alkylene, substituted or unsubstituted C₅-C₇ cycloalkylene, substituted or unsubstituted C₁-C₈ alkylene C₅-C₇ cycloalkylene and substituted or unsubstituted C₆-C₇ arylene C₁-C₈ alkylene C₆-C₇ arylene.

In another preferred embodiment, R_{b}, R_{c}, R_{d}, Rₑ, R_{f} and R_{g} independently of each other are selected from the group consisting of linear or branched, substituted or unsubstituted C₁-C₃₀ alkyl, substituted or unsubstituted C₅-C₃₀ cycloalkyl, substituted or unsubstituted C₆-C₃₀ aryl and substituted or unsubstituted 5- to 30-membered heteroaryl,

R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 30-membered carbocyclic ring that contains 0, 1, 2 or 3 heteroatom(s) selected from O, N or S as ring member(s);
more preferably R_{b}, R_{c}, R_{d}, Rₑ, R_{f} and R_{g} independently of each other are selected from the group consisting of linear or branched, substituted or unsubstituted C₁-C₂₀ alkyl, substituted or unsubstituted C₅-C₂₀ cycloalkyl, substituted or unsubstituted C₆-C₂₀ aryl and substituted or unsubstituted 5- to 20-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 20-membered carbocyclic ring that contains 0, 1, 2 or 3 heteroatom(s) selected from O, N or S as ring member(s);
even more preferably R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₁₀ cycloalkyl, substituted or unsubstituted C₆-C₁₀ aryl and substituted or unsubstituted 5- to 10-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1, 2 or 3 heteroatom(s) selected from O, N or S as ring member(s); most preferably R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₇ cycloalkyl, substituted or unsubstituted C₆-C₇ aryl, and substituted or unsubstituted 5- to 7-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1, 2 or 3 heteroatom(s) selected from O, N or S as ring member(s); and in particular R_{b}, R_{c}, R_{d}, Rₑ, R_{f} and R_{g} independently of each other are selected from the group consisting of linear or branched, substituted or unsubstituted C₁-C₁₀ alkyl, substituted or unsubstituted C₅-C₇ cycloalkyl, substituted or unsubstituted C₆-C₇ aryl, and substituted or unsubstituted 5- to 7-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 10-membered carbocyclic ring that contains 0, 1 or 2 heteroatom(s) selected from O or N as ring member(s).

In another preferred embodiment, R_{b}, R_{c}, R_{d}, Rₑ, R_{f} and R_{g} independently of each other are selected from the group consisting of hydrogen, linear or branched, substituted or unsubstituted C₁-C₃₀ alkyl, substituted or unsubstituted C₅-C₃₀ cycloalkyl and substituted or unsubstituted C₈-C₃₀ aryl;

R_{b} and Rₑ together with the carbon atoms to which they are bonded, or
R_{c} and R_{d} together with the carbon atoms to which they are bonded, or
R_{f} and Rₑ together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s).

In another preferred embodiment, Rₐ is selected from the group consisting of substituted or unsubstituted, linear or branched C₁-C₁₀ alkylene, substituted or unsubstituted, linear or branched C₂-C₃₀ alkenylene, substituted or unsubstituted C₅-C₁₀ cycloalkylene, substituted or unsubstituted C₅-C₈ cycloalkenylene, substituted or unsubstituted C₆-C₁₀ arylene, substituted or unsubstituted C₁-C₁₀ alkylene C₅-C₅ cycloalkylene, substituted or unsubstituted C₁-C₁₀ alkylene 5- to 10-membered heterocycloalkylene, substituted or unsubstituted C₁-C₁₀ alkylene C₆-C₁₀ arylene, C₅-C₁₀ cycloalkylene and substituted or unsubstituted C₂-C₁₀ alkenylene 5- to 10-membered heterocycloalkylene.

In another preferred embodiment, the secondary amine of formula (B) is selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N′-diisopropyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

In another preferred embodiment, the secondary amine of formula (B) comprises primary amine.

In another preferred embodiment, the primary amine is present in the secondary amine of formula (B) in an amount in the range of 0 to 10 wt. % based on overall weight of the secondary amine of formula (B), more preferably the primary amine is present in the secondary amine of formula (B) in an amount in the range of 0 to 8 wt. % based on overall weight of the secondary amine of formula (B), even more preferably the primary amine is present in the secondary amine of formula (B) in an amount in the range of 0.5 to 5 wt. % based on overall weight of the secondary amine of formula (B), most preferably the primary amine is present in the secondary amine of formula (B) in an amount in the range of 1 to 4 wt. % based on overall weight of the secondary amine of formula (B), and in particular the primary amine is present in the secondary amine of formula (B) in an amount in the range of 1 to 3 wt. % based on overall weight of the secondary amine of formula (B).

In another preferred embodiment, the isocyanate mixture (A) comprises at least one isocyanate which has an NCO functionality of 3.0.

In another preferred embodiment, the at least one isocyanate which has an NCO functionality of 3.0 is selected from the group consisting of triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1 h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric forms of triisocyanates.

By the term “polymeric”, it is referred to the polymeric grade of the aliphatic polyisocyanate and/or aromatic polyisocyanate comprising, independently of each other, different oligomers and homologues.

In another preferred embodiment, the polymeric form of the diisocyanate is polymeric methylene diphenyl diisocyanate.

In another preferred embodiment, the polymeric forms of diisocyanates and triisocyanates comprise polymeric methylene diphenyl diisocyanate and toluene diisocyanate.

In another preferred embodiment, the polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of ≥2.10, preferably ≥3.0. The isomeric ratio as well as the amount of oligomeric species can vary in wide ranges in these products. For instance, polymeric methylene diphenyl diisocyanate may typically contain about 30 to 80 wt. % of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene diphenyl diisocyanate.

In another preferred embodiment, wherein the isocyanate mixture (A) comprises at least one isocyanate which has an NCO functionality of =2.0.

In another preferred embodiment, the at least one isocyanate which has an NCO functionality of =2.0 is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-di isocyanate, nonamethylene diisocyanate, 2,2,4-trimethylhexamethylene-1,6-diisocyanate, decamethylene-1,10-diisocyanate, 2,11-di isocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-bi phenylene di isocyanate, 3,3′-dimethyl-4,4′-biphenylene di isocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO; more preferably the at least one isocyanate which has an NCO functionality of =2.0 is selected from the group consisting of isophorone diisocyanate, propylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2′-diphenylsulfone diisocyanate, 3,3′-diphenylsulfone diisocyanate, 4,4′-diphenylsulfone diisocyanate, 2,2-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO; even more preferably the at least one isocyanate which has an NCO functionality of =2.0 is selected from the group consisting of isophorone diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2′-diphenylsulfone diisocyanate, 3,3′-diphenylsulfone diisocyanate, 4,4′-diphenylsulfone diisocyanate, 2,2-methylene-bis(cyclohexyl isocyanate), 3,3′-methylene-bis(cyclohexyl isocyanate), 4,4′-methylene-bis(cyclohexyl isocyanate), 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO; most preferably the at least one isocyanate which has an NCO functionality of =2.0 is selected from the group consisting of isophorone diisocyanate, hexamethylene-1,6-diisocyanate, 1,5-pentamethylene diisocyanate, octamethlyene-1,8-diisocyanate, meta-phenylene diisocyanate, para-phenylene diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2′-diphenylsulfone diisocyanate, 3,3′-diphenylsulfone diisocyanate, 4,4′-diphenylsulfone diisocyanate, 2,2-methylene-bis(cyclohexyl isocyanate), 3,3′-methylene-bis(cyclohexyl isocyanate), 4,4′-methylene-bis(cyclohexyl isocyanate), 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO; and in particular the at least one isocyanate which has an NCO functionality of =2.0 is selected from the group consisting of isophorone diisocyanate, hexamethylene-1,6-diisocyanate, 1,5-pentamethylene diisocyanate, octamethlyene-1,8-diisocyanate, meta-phenylene diisocyanate, para-phenylene diisocyanate, toluene-2,4-diisocyanate, toluene-2,6-diisocyanate, 2,2′-biphenylene diisocyanate, 3,3′-biphenylene diisocyanate, 4,4′-biphenylene diisocyanate, methylene-bis(4-phenyl isocyanate), 2,2-methylene-bis(cyclohexyl isocyanate), 3,3′-methylene-bis(cyclohexyl isocyanate), 4,4′-methylene-bis(cyclohexyl isocyanate), and 1,4-diisocyanato cyclohexane and polymeric forms of diisocyanates.

In another preferred embodiment, the polymeric forms of diisocyanates comprise polymeric methylene diphenyl diisocyanate and toluene diisocyanate.

In another preferred embodiment, the at least one isocyanate is present in the form of a dimer, a trimer or an oligomer containing a urethane group, an isocyanurate group, a biuret group, an uretdione group, an allophanate group and/or an iminooxadiazinedione group.

In another preferred embodiment, the polyurea copolymer has a weight average molecular weight Mw in the range of 500 g/mol to 5,00,000 g/mol, determined according to the DIN 55672 or in case of high molecular weights where the polymeric material is not soluble in standard organic solvents anymore the molecular weight is determined according to the MALDI-TOF Mass Spectrometry; more preferably the polyurea copolymer has a weight average molecular weight Mw in the range of 1000 g/mol to 2,00,000 g/mol, determined according to the DIN 55672 or in case of high molecular weights where the polymeric material is not soluble in standard organic solvents anymore the molecular weight is determined according to the MALDI-TOF Mass Spectrometry; even more preferably the polyurea copolymer has a weight average molecular weight Mw in the range of 2000 g/mol to 1,00,000 g/mol, determined according to the DIN 55672 or in case of high molecular weights where the polymeric material is not soluble in standard organic solvents anymore the molecular weight is determined according to the MALDI-TOF Mass Spectrometry; most preferably the polyurea copolymer has a weight average molecular weight Mw in the range of 3000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry; particular preferably the polyurea copolymer has a weight average molecular weight Mw in the range of 5000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry and still in even particular preferably the polyurea copolymer has a weight average molecular weight Mw in the range of 5000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

In another preferred embodiment, the polyurea copolymer has the molar ratio of NCO in the isocyanate mixture (A) to —NH— in the at least one secondary amine of formula (B) is in the range of ≥1.0:3.0 to ≤3.0:1.0; more preferably the polyurea copolymer has the molar ratio of NCO in the isocyanate mixture (A) to —NH— in the at least one secondary amine of formula (B) is in the range of ≥1.0:2.5 to ≤2.5:1.0; even more preferably the polyurea copolymer has the molar ratio of NCO in the isocyanate mixture (A) to —NH— in the at least one secondary amine of formula (B) is in the range of ≥1.0:2.0 to ≤2.0:1.0; and most preferably the polyurea copolymer has the molar ratio of NCO in the isocyanate mixture (A) to —NH— in the at least one secondary amine of formula (B) is in the range of ≥1.0:0.5 to ≤0.5:1.0.

In another preferred embodiment, the polyurea copolymer has a glass transition temperature in the range of ≥−20° C. to ≤250° C., determined according to ASTM D 3418 using a heating rate of 5 K/min; more preferably the polyurea copolymer has a glass transition temperature in the range of ≥0° C. to ≤200° C., determined according to ASTM D 3418 using a heating rate of 5 K/min; even more preferably the polyurea copolymer has a glass transition temperature in the range of ≥0° C. to ≤180° C., determined according to ASTM D 3418 using a heating rate of 5 K/min; most preferably the polyurea copolymer has a glass transition temperature in the range of ≥20° C. to ≤160° C., determined according to ASTM D 3418 using a heating rate of 5 K/min; and in particular the polyurea copolymer has a glass transition temperature in the range of ≥40° C. to ≤150° C., determined according to ASTM D 3418 using a heating rate of 5 K/min.

In another preferred embodiment, the presently claimed invention is directed to a process for preparing a polyurea copolymer comprising at least the steps of:

i) providing an isocyanate mixture (A) which has an average NCO functionality ≥2.10;
ii) providing at least one secondary amine of formula (B),

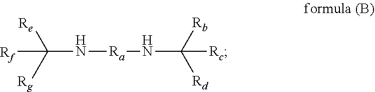

wherein Rₐ is selected from the group consisting of substituted or unsubstituted, linear or branched C₁-C₃₀ alkylene, substituted or unsubstituted, linear or branched 2- to 30-membered heteroalkylene, substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene substituted or unsubstituted 5- to 30-membered heterocycloalkenylene,
substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene, substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s), and
   iii) contacting (A) and (B);
   more preferably the process for preparing a polyurea copolymer comprising at least the steps of:
   i) providing an isocyanate mixture (A) which has an average NCO functionality of ≥2.10;
   ii) providing at least one secondary amine of formula (B),

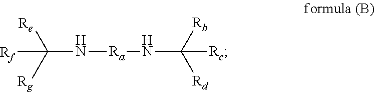

wherein Rₐ is selected from the group consisting of substituted or unsubstituted, linear or branched C₁-C₃₀ alkylene, substituted or unsubstituted, linear or branched C₂-C₃₀ alkenylene, substituted or unsubstituted C₅-C₃₀ cycloalkylene, substituted or unsubstituted 5- to 30-membered heterocycloalkylene, substituted or unsubstituted C₅-C₃₀ cycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₅-C₃₀ cycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkenylene and substituted or unsubstituted C₂-C₃₀ alkenylene C₆-C₃₀ arylene, and R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s); and
iii) contacting (A) and (B);
most preferably the process for preparing a polyurea copolymer comprising at least the steps of:
i) providing an isocyanate mixture (A) which has an average NCO functionality of ≥2.10;
ii) providing at least one secondary amine of formula (B),

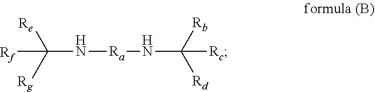

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene and substituted or unsubstituted C₂-C₃₀ alkenylene C₆-C₃₀ arylene, and
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s); and
iii) contacting (A) and (B); and
in particular the process for preparing a polyurea copolymer comprising at least the steps of:
i) providing an isocyanate mixture (A) which has an average NCO functionality of ≥2.10;
ii) providing at least one secondary amine of formula (B),

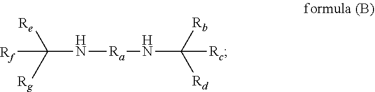

wherein Rₐ is selected from the group consisting of substituted or unsubstituted, linear or branched C₁-C₃₀ alkylene, substituted or unsubstituted C₅-C₃₀ cycloalkylene, substituted or unsubstituted 5- to 30-membered heterocycloalkylene, substituted or unsubstituted C₆-C₃₀ arylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene C₆-C₃₀ arylene and substituted or unsubstituted C₆-C₃₀ arylene C₁-C₃₀ alkylene C₆-C₃₀ arylene, R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₃₀ cycloalkyl and substituted or unsubstituted C₆-C₃₀ aryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s);
iii) contacting (A) and (B).

In another preferred embodiment, the molar ratio of NCO in the isocyanate mixture (A) to —NH— in the at least one secondary amine of formula (B) is in the range of ≥1.0:3 to ≤3:1.0; more preferably the polyurea copolymer has the molar ratio of NCO in the isocyanate mixture (A) to —NH— in the at least one secondary amine of formula (B) is in the range of ≥1.0:2.5 to ≤2.5:1.0; even more preferably the molar ratio of NCO in the isocyanate mixture (A) to —NH— in the at least one secondary amine of formula (B) is in the range of ≥1.0:2.0 to ≤2.0:1.0; and most preferably the molar ratio of NCO in the isocyanate mixture (A) to —NH— in the at least one secondary amine of formula (B) is in the range of ≥1.0:0.5 to ≤0.5:1.0.

In another preferred embodiment, the molar ratio of NCO in the isocyanate mixture (A) to —NH— in the at least one secondary amine of formula (B) is in the range of ≥1.0:0.5 to ≤0.5:1.0.

In another preferred embodiment, in the process for preparing a polyurea copolymer the step iii) carried out at a temperature in the range of ≥−50° C. to ≤250° C.; more preferably the step iii) carried out at a temperature in the range of ≥0° C. to ≤200° C.; even more preferably the step iii) carried out at a temperature in the range of ≥20° C. to ≤180° C.; most preferably the step iii) carried out at a temperature in the range of ≥40° C. to ≤160° C.; and in particular the step iii) carried out at a temperature in the range of ≥60° C. to ≤140° C.

In another preferred embodiment, the process for preparing a polyurea copolymer is carried out in the presence of at least one solvent.

In another preferred embodiment, the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

In another preferred embodiment, the presently claimed invention is directed to an article comprising a polyurea copolymer.

In another preferred embodiment the article includes coatings, healable coatings, recyclable rigid foams, recyclable flexible foams, parts for the automotive industry, recyclable rigid foams, rigid foam insulation, durable elastomeric wheels and tires, adhesives, surface coatings and surface sealants, synthetic fibers, carpet underlay, hard-plastic parts

In another preferred embodiment, the presently claimed invention is directed to a process for reshaping a polyurea copolymer comprising at least the steps of:
a) applying pressure and heat to the polyurea copolymer to obtain a heated polyurea copolymer; and
b) shaping the heated polyurea copolymer of step a).

In another preferred embodiment, in the process of reshaping the polyurea copolymer is performed at a pressure in the range of ≥5×10³ Pa to ≤10⁷ Pa.

In another preferred embodiment, in the process of reshaping the polyurea copolymer is performed at a temperature in the range of ≥60° C. to ≤300° C.

The presently claimed invention is associated with at least one of the following advantages:

(i) A new class of polyurea copolymer has been developed with dynamic bonds.
(ii) A new class of polyurea copolymer has been developed with recyclability.
(iii) A new of polyurea copolymer has been developed with a three-dimensional network structure based on reacting polyisocyanates and polyamines only without the use of additional cross linker.

### Embodiments

1. A polyurea copolymer obtained by reacting a reaction mixture comprising:

a. an isocyanate mixture (A); and b. at least one secondary amine of formula (B)

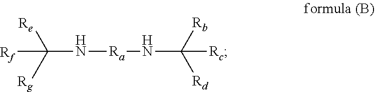

wherein Rₐ is selected from the group consisting of substituted or unsubstituted, linear or branched C₁-C₃₀ alkylene, substituted or unsubstituted, linear or branched 2- to 30-membered heteroalkylene, substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene,
substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅-C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s); and
wherein the isocyanate mixture (A) has an average NCO functionality of ≥2.10.

2. The polyurea copolymer according to the embodiment 1, wherein the isocyanate mixture (A) has an average NCO functionality in the range of ≥2.10 to ≤6.0.

3. The polyurea copolymer according to the embodiment 1 or 2, wherein Rₐ is selected from the group consisting of substituted or unsubstituted, linear or branched C₁-C₃₀ alkylene, substituted or unsubstituted C₅-C₃₀ cycloalkylene, substituted or unsubstituted C₁-C₃₀ alkylene C₅-C₃₀ cycloalkylene and substituted or unsubstituted C₆-C₃₀ arylene C₁-C₃₀ alkylene C₆-C₃₀ arylene.

4. The polyurea according to any one of the embodiment 1 to 3, wherein R_{b}, R_{c}, R_{d}, Rₑ, R_{f} and R_{g} independently of each other are selected from the group consisting of linear or branched, substituted or unsubstituted C₁-C₃₀ alkyl, substituted or unsubstituted C₅-C₃₀ cycloalkyl, substituted or unsubstituted C₆-C₃₀ aryl and substituted or unsubstituted 5- to 30-membered heteroaryl,

R_{b} and Rₑ together with the carbon atoms to which they are bonded, or
R_{c} and R_{f} together with the carbon atoms to which they are bonded, or
R_{d} and R_{g} together with the carbon atoms to which they are bonded, or
R_{c} and R_{d} together with the carbon atoms to which they are bonded, or
R_{c} and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 30-membered carbocyclic ring that contains 0, 1, 2 or 3 heteroatom(s) selected from O, N or S as ring member(s).

5. The polyurea according to any one of embodiments 1 to 4, wherein none of Rₐ, R_{b}, R_{c}, R_{d}, Rₑ, R_{f} and R_{g} is substituted with —OH.

6. The polyurea according to any one of the embodiment 1 to 5, wherein the secondary amine of formula (B) is selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N′-diisopropyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

7. The polyurea copolymer according to any one of the embodiments 1 to 6, wherein the isocyanate mixture (A) comprises at least one isocyanate which has an NCO functionality of 3.0.

8. The polyurea copolymer according to the embodiment 7, wherein the at least one isocyanate which has an NCO functionality of 3.0 is selected from the group consisting of triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric forms of diisocyanates and triisocyanates.

9. The polyurea copolymer according to any one of the embodiments 1 to 8, wherein the isocyanate mixture (A) comprises at least one isocyanate which has an NCO functionality of =2.0.

10. The polyurea copolymer according to the embodiment 9, wherein the at least one isocyanate which has an NCO functionality of =2.0 is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO and polymeric forms of disiocyantes.

11. The polyurea copolymer according to any one of the embodiments 1 to 10, wherein the at least one isocyanate is present in the form of a dimer, a trimer or an oligomer containing a urethane group, an isocyanurate group, a biuret group, an uretdione group, an allophanate group and/or an iminooxadiazinedione group.

12. The product according to the embodiments 1 to 11, wherein the molar ratio of NCO in the isocyanate mixture (A) to the secondary amine (B) is in the range of 1.0:10 to 10:1.0.

13. The product according to the embodiment 12, wherein the molar ratio of NCO in the isocyanate mixture (A) to the secondary amine (B) is in the range of 1.0:2.5 to 2.5:1.0.

14. The product according to the embodiment 13, wherein the molar ratio of NCO in the isocyanate mixture (A) to the secondary amine (B) is in the range of 1.0:2.0 to 2.0:1.0.

15. The product according to the embodiments 1 to 14, wherein the polyurea copolymer has a weight average molecular weight Mw in the range of 3000 g/mol to 80,000 g/mol, determined according to the DIN 55672.

16. The product according to the embodiment 15, wherein the polyurea copolymer has a weight average molecular weight Mw in the range of 3000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

17. The product according to the embodiment 16, wherein the polyurea copolymer has a weight average molecular weight Mw in the range of 5000 g/mol to 20,000 g/mol, determined according to the DIN 55672 or in case of high molecular weights where the polymeric material is not soluble in standard organic solvents anymore the molecular weight is determined according to the MALDI-TOF Mass Spectrometry.

18. A process for preparing a polyurea copolymer according to any one of the embodiments 1 to 17 comprising at least the steps of:
i) providing an isocyanate mixture (A) which has an average NCO functionality of ≥2.10;
ii) providing at least one secondary amine of formula (B),

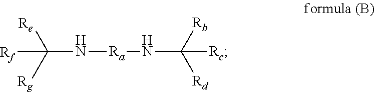

wherein Rₐ, R_{b}, R_{c}, R_{d}, Rₑ, R_{f} and R_{g} are defined as in any of embodiment 1 to 10, and
iii) contacting (A) and (B).

19. The process according to the embodiment 18, wherein the molar ratio of NCO in the isocyanate mixture (A) to the secondary amine (B) is in the range of ≥1.0:10 to ≤10:1.0.

20. The process according to the embodiment 19, wherein the molar ratio of NCO in the isocyanate mixture (A) to the secondary amine (B) is in the range of ≥1.0:2.5 to ≤2.5:1.0.

21. The process according to the embodiment 20, wherein the molar ratio of NCO in the isocyanate mixture (A) to the secondary amine (B) is in the range of ≥1.0:0.5 to ≤0.5:1.0.

22. The process according to any one of the embodiments 18 to 21, wherein step iii) carried out at a temperature in the range of ≥−50° C. to ≤250° C.

23. The process according to any one of the embodiments 18 to 22, wherein step iii) is carried out in the presence of at least one solvent.

24. The process according to the embodiment 23, wherein the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

25. An article comprising a polyurea copolymer according to any one of the embodiments 1 to 17 or a polyurea copolymer obtained according to any one of the embodiments 18 to 21.

26. A process for reshaping a polyurea copolymer according to any one of the embodiments 1 to 17 or a polyurea copolymer obtained according to any one of embodiments 18 to 21 or an article according to the embodiment 25 comprising at least the steps of:

a) applying pressure and heat to the polyurea copolymer to obtain a heated polyurea copolymer; and
b) shaping the heated polyurea copolymer of step a).

27. The process according to the embodiment 26, wherein the pressure is the range of ≥5×10³ Pa to ≤10⁷ Pa.

28. The process according to the embodiment 27, wherein the temperature is the range of ≥60° C. to ≤300° C.

While the presently claimed invention has been described in terms of its specific embodiments, certain modifications and equivalents will be apparent to those skilled in the art and are intended to be included within the scope of the presently claimed invention

### EXAMPLES

### Materials

PMDI (Lupranat M20 FB) was obtained from BASF; 4,4′-Methylenebis(N-sec-butylaniline) (“DIB-MDA”) was purchased from ABCR. MCDA and T5 amine were obtained from BASF. All other chemicals were obtained from Sigma Aldrich (Germany) and used as received unless otherwise specified. The modified MCDA-amines as well as DIP-IPDA were all synthesized in our laboratories by reductive amination (procedure see below). THF was dried using molecular sieves (4 A).

PMDI: Polymeric diphenylmethane diisocyanate.
MCDA: Mixture of 4-methyl-cyclohexane-1,3-diamine and 2-methyl-cyclohexane-1,3-diamine as well as all possible stereoisomers.
DIP-MCDA: Mixture of N1,N3-diisopropyl-4-methyl-cyclohexane-1,3-diamine and N1,N3-diisopropyl-2-methyl-cyclohexane-1,3-diamine as well as all possible stereoisomers.
Bbz-MCDA: Mixture of N1,N3-dibenzyl-4-methyl-cyclohexane-1,3-diamine and N1,N3-dibenzyl-2-methyl-cyclohexane-1,3-diamine as well as all possible stereoisomers.
EtHex-MCDA: Mixture of N1,N3-bis(2-ethylhexyl)-4-methyl-cyclohexane-1,3-diamine and N1,N3-bis(2-ethylhexyl)-2-methyl-cyclohexane-1,3-diamine as well as all possible stereoisomers.
DIP-IPDA: N-isopropyl-3-[(isopropylamino)methyl]-3,5,5-trimethyl-cyclohexanamine.
DIB-MCDA: Mixture of N1,N3-disec-butyl)-4-methyl-cyclohexane-1,3-diamine and N1,N3-disec-butyl-2-methyl-cyclohexane-1,3-diamine as well as all possible stereoisomers.
DIB-MDA: N-sec-butyl-4-[[4-(sec-butylamino)phenyl]methyl]aniline.
T5-Amine: N,N-bis(2,2,6,6-tetramethyl-4-piperidyl)hexane-1,6-diamine.

### Methods

DSC was used to determine the reaction enthalpy and the glass transition temperature according to ASTM D 3418 using a heating rate of 5 K/min.

Residual NCO content was determined by IR spectroscopy.

TGA spectra were obtained according to ASTM E1131, ISO 11358 under N₂ atmosphere in gold crucibles.

### Method for Thermal Reshaping

### Test Method:

The polymer powder/granulate obtained according to the examples was transferred to a hot press. When applying 20 kN of pressure and 160-180° C. for at least 5 minutes, the polymer powder was reshaped to a solid, cookie-shaped plate.

The polymer powder obtained according to present invention was reshaped in cookies/plate. In contrast, when using polymer powder obtained according to comparative examples, no solid cookie/plate was obtained. Instead, since the comparative material is not malleable, it stayed a white, opaque solid and fell apart easily.

### Synthesis of MCDA-Based Secondary Amines:

### N¹,N³-Diisopropyl-4-methylcyclohexane-1,3-diamine (DiP-MCDA)

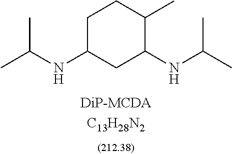

A 3.5 L steel pressure autoclave was charged with TiO₂ (75 g, 10 wt.-%) and suspended with MCDA (730 g, 5.70 mol, 1.0 equiv.) under a nitrogen atmosphere. Next, acetone (1322 g, 1674 mL, 22.8 mol, 4.0 equiv.) was dropwise added at 100° C. and stirred for 8 h before being filtered. The residual yellow crude diimine was transferred to a 3.5 L steel pressure autoclave and suspended with a [Pd] on Al₂O₃ catalyst (75 g, 10 wt.-%), before the system was introduced to a 100 bar H₂ atmosphere and stirred for 8 h. After complete conversion monitored by GC, the system was cooled to rt and vented with nitrogen. Volatiles were then removed under reduced pressure and the crude compound was purified by distillation under reduced pressure (b.p. 126° C.; 20 mbar) to give a colorless oil of the desired target compound (1170 g, 84% yield, >99.5% purity).

### Analytics:

GC (DB1 column, 30 m; 100° C. (12 min), 10° C./min, 250° C. (8 min): t_{R}=19.79 min

### Example 4

Polymeric methylene diphenylisocyanate (pMDI) (16.52 g, f=2.53) and THF (250 g) were charged in a flask and cooled using an ice bath. A sterically hindered secondary diamine, DIP-MCDA (13 g) in 50 g of THF was slowly added to form polyurea. After stirring for 1 hour, the reaction mixture was warmed to room temperature. Stirring was continued until polymerization was complete, which was confirmed by disappearance of the NCO band in IR. THF was evaporated under reduced pressure. The resulting material was crushed and dried under reduced pressure to remove residual traces of THF. The product was obtained as a slightly yellowish solid in quantitative yield.

### Example 12

Polymeric methylene diphenylisocyanate (pMDI) (16.52 g, f=2.53) and THF (250 g) were charged in a flask and cooled using an ice bath. A sterically hindered secondary diamine, N-sec-butyl-4-[[4-(sec-butylamino)phenyl]methyl]aniline (19.02 g) in 50 g of THF was slowly added to form polyurea. After stirring for 1 hour, the reaction mixture was warmed to room temperature. Stirring was continued until polymerization was complete, which was confirmed by disappearance of the NCO band in IR. THF was evaporated under reduced pressure. The resulting material was crushed and dried under reduced pressure to remove residual traces of THF. The product was obtained as a slightly yellowish solid in quantitative yield.

### Results

TABLE 1

| | | | Peak of | | | Thermal reshaping | |
|---|---|---|---|---|---|---|---|
| | Ratio | Ratio | exothermic | Reaction | | [Conditions: | |
| | PMDI:DIP- | NCO:sec. | reaction by | enthalpy by | Residual | 20 kN, 180° C., | |
| Exp. No. | MCDA | amine | DSC [° C.] | DSC [J/g] | NCO (IR) | 5 min] | Healable |
| 2 | 1.25:1.0 | 1.58:1.0 | 184 | 27 | yes | yes | yes |
| 3 | 1.0:1.0 | 1.26:1.0 | 179 | 11 | yes | yes | yes |
| 4 | 0.8:1.0 | 1.01:1.0 | 179 | 14 | traces | yes | yes |
| 5 | 0.66:1.0 | 0.83:1.0 | 180 | 39 | no | yes | yes |
| 6 | 0.6:1.0 | 0.76:1.0 | 174 | 18 | no | yes | yes |
| 7 | 0.55:1.0 | 0.70:1.0 | none | none | no | yes | yes |

TABLE 2

| | | Thermal Reshaping | TGA | |
|---|---|---|---|---|
| Expt. | | [Conditions: 20 kN, | 5% mass | |
| No. ^{a, b, c} | sec. amine | 180° C., 5 min] | loss | Healable |
| 4 | DIP-MCDA | Yes | 173 | Yes |
| 8 | DIB-MCDA | Yes | 220 | Yes |
| 9 | BBz-MCDA | Yes | 171 | Yes |
| 10 | EtHex-MCDA | Yes | 212 | Yes |
| 11 | DIP-IPDA | Yes | 210 | Yes |
| 12 | DIB-MDA | Yes | 173 | Yes |
| 13 | T5-Amine | Yes | 244 | Yes |
| 14 | MCDA | NO | 110 | NO |
| Comparative | | | | |

^{a} Isocyanate PMDI
^{b} Ratio PMDI: sec. amine 08:1.0
^{c} Ratio NCO: sec. amine 1.0:1.0

### Comparative Experiment:

| | | | | | | |
|---|---|---|---|---|---|---|
| | Ratio | Ratio | | | | Thermal Reshaping |
| Comparative | TDI:DIP- | NCO:sec. | | | Residual | [Conditions: 20 kN, |
| Exp. No. | MCDA | amine | Tg ° C. | Exo ° C. | NCO (IR) | 180° C., 5 min] |

| | | | | |
|---|---|---|---|---|
| Comp. 1 | 1.0:1.0 | 1.0:1.0 | No | cookie melts, forms |
| (no cross | | | | bubbles, not stable |
| linker) | | | | |

Thermosets are the material of choice for many applications due to their stability, mechanical properties, and chemical resistance—properties that result from the permanently cross-linked molecular network they consist of. In contrast to thermoplastics though, thermosets cannot be thermally reshaped and therefore not easily recycled.

The presently invention provides a new class of polyurea copolymer which can be recycled. It is evident from above examples that the use of polymeric diisocyanates lead to formation of recyclable polyurea copolymer having 3-dimensional network structure with dynamic urea bonds. This introduction of exchangeable chemical bonds is an attractive chemical strategy to combine the stability of thermosets with the processability of thermoplastics.

In contrast to prior art, the material does not require additional crosslinking agents like trifunctional alcohols/amines/etc. Instead, the cross-linking is achieved by using isocyanates with functionality >2.0 (≥2.1).

1.-28. (canceled)

29. A polyurea copolymer obtained by reacting a reaction mixture comprising:
a. an isocyanate mixture (A); and
b. at least one secondary amine of formula (B) 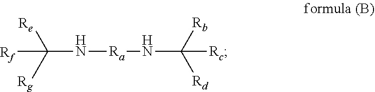
wherein Rₐ is selected from the group consisting of substituted or unsubstituted, linear or branched C₁-C₃₀ alkylene, substituted or unsubstituted, linear or branched 2- to 30-membered heteroalkylene,
substituted or unsubstituted, linear or branched C₂-C₃₀ alkenylene, substituted or unsubstituted, linear or branched 3- to 30-membered heteroalkenylene, substituted or unsubstituted C₅-C₃₀ cycloalkylene,
substituted or unsubstituted 5- to 30-membered heterocycloalkylene, substituted or unsubstituted C₅-C₃₀ cycloalkenylene, substituted or unsubstituted 5- to 30-membered heterocycloalkenylene, substituted or unsubstituted C₆-C₃₀ arylene, substituted or unsubstituted 5- to 30-membered heteroarylene, substituted or unsubstituted C₁-C₃₀ alkylene C₅-C₃₀ cycloalkylene, substituted or unsubstituted C₅-C₃₀ cycloalkylene C₁-C₃₀ alkylene C₅-C₃₀ cycloalkylene, substituted or unsubstituted C₁-C₃₀ alkylene 5- to 30-membered heterocycloalkylene, substituted or unsubstituted C₁-C₃₀ alkylene C₅-C₃₀ cycloalkenylene,
substituted or unsubstituted C₁-C₃₀ alkylene 5- to 30-membered heterocycloalkenylene, substituted or unsubstituted C₁-C₃₀ alkylene C₆-C₃₀ arylene, substituted or unsubstituted C₆-C₃₀ arylene C₁-C₃₀ alkylene C₆-C₃₀ arylene, substituted or unsubstituted C₁-C₃₀ alkylene 5- to 30-membered heteroarylene, substituted or unsubstituted C₂-C₃₀ alkenylene C₅-C₃₀ cycloalkylene, substituted or unsubstituted C₂-C₃₀ alkenylene 5- to 30-membered heterocycloalkylene, substituted or unsubstituted C₂-C₃₀ alkenylene C₅—C₃₀ cycloalkenylene, substituted or unsubstituted C₂-C₃₀ alkenylene 5- to 30-membered heterocycloalkenylene, substituted or unsubstituted C₂-C₃₀ alkenylene C₆-C₃₀ arylene, and substituted or unsubstituted C₂-C₃₀ alkenylene 5- to 30-membered heteroarylene,
R_{b}, R_{c}, R_{d}, Rₑ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ together with the carbon atoms to which they are bonded, or
Rₑ and R_{f} together with the carbon atoms to which they are bonded, or
R_{d} and R_{g} together with the carbon atoms to which they are bonded, or
Rₑ and R_{d} together with the carbon atoms to which they are bonded, or
Rₑ and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, unsaturated or aromatic, unsubstituted or substituted 5- to 30-membered carbocyclic ring that contains 0, 1, 2 or 3 heteroatom(s) selected from O, N or S as ring member(s); and
wherein the isocyanate mixture (A) has an average NCO functionality of ≥2.10.

30. The polyurea copolymer according to the claim 29, wherein the isocyanate mixture (A) has an average NCO functionality in the range of ≥2.10 to ≤6.0.

31. The polyurea copolymer according to the claim 29, wherein Rₐ is selected from the group consisting of substituted or unsubstituted, linear or branched C₁-C₃₀ alkylene, substituted or unsubstituted C₅-C₃₀ cycloalkylene, substituted or unsubstituted C₁-C₃₀ alkylene C₅-C₃₀ cycloalkylene and substituted or unsubstituted C₆-C₃₀ arylene C₁-C₃₀ alkylene C₆-C₃₀ arylene.

32. The polyurea according to claim 29, wherein R_{b}, Rₑ, R_{d}, Rₑ, R_{f} and R_{g} independently of each other are selected from the group consisting of linear or branched, substituted or unsubstituted C₁-C₃₀ alkyl, substituted or unsubstituted C₅-C₃₀ cycloalkyl, substituted or unsubstituted C₆-C₃₀ aryl and substituted or unsubstituted 5- to 30-membered heteroaryl,
R_{b} and Rₑ together with the carbon atoms to which they are bonded, or
Rₑ and R_{f} together with the carbon atoms to which they are bonded, or
R_{d} and R_{g} together with the carbon atoms to which they are bonded, or
Rₑ and R_{d} together with the carbon atoms to which they are bonded, or
Rₑ and R_{b} together with the carbon atoms to which they are bonded, or
R_{b} and R_{d} together with the carbon atoms to which they are bonded, or
R_{f} and Rₑ together with the carbon atoms to which they are bonded, or
Rₑ and R_{g} together with the carbon atoms to which they are bonded, or
R_{f} and R_{g} together with the carbon atoms to which they are bonded form a saturated, or unsaturated, unsubstituted or substituted 5- to 30-membered carbocyclic ring that contains 0, 1, 2 or 3 heteroatom(s) selected from O, N or S as ring member(s).

33. The polyurea according to claim 29, wherein none of Rₐ, R_{b}, Rₑ, R_{d}, Rₑ, R_{f} and R_{g} is substituted with —OH.

34. The polyurea according to claim 29, wherein the secondary amine of formula (B) is selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-di amine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N′-diisopropyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

35. The polyurea copolymer according to claim 29, wherein the isocyanate mixture (A) comprises at least one isocyanate which has an NCO functionality of ≥3.0.

36. The polyurea copolymer according to the claim 35, wherein the at least one isocyanate which has an NCO functionality of ≥3.0 is selected from the group consisting of triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric forms of diisocyanates and triisocyanates.

37. The polyurea copolymer according to claim 29, wherein the isocyanate mixture (A) comprises at least one isocyanate which has an NCO functionality of =2.0.

38. The polyurea copolymer according to the claim 37, wherein the at least one isocyanate which has an NCO functionality of =2.0 is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenyl sulfone diisocyanate, 4,4′-diphenyl sulfone diisocyanate, 2,2-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2,4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyanobiadamantane, 3,3-diiso-cyanatoethyl-1′-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO and OCN(CH₂)₃N(CH₃)(CH₂)₃NCO and polymeric forms of disiocyantes.

39. The polyurea copolymer according to claim 29, wherein the at least one isocyanate is present in the form of a dimer, a trimer or an oligomer containing a urethane group, an isocyanurate group, a biuret group, an uretdione group, an allophanate group and/or an iminooxadiazinedione group.

40. The product according to claim 29, wherein the molar ratio of NCO in the isocyanate mixture (A) to the secondary amine (B) is in the range of ≥1.0:10 to ≤10:1.0.

41. The product according to the claim 40, wherein the molar ratio of NCO in the isocyanate mixture (A) to the secondary amine (B) is in the range of ≥1.0:2.5 to ≤2.5:1.0.

42. The product according to the claim 41 wherein the molar ratio of NCO in the isocyanate mixture (A) to the secondary amine (B) is in the range of ≥1.0:2.0 to ≤2.0:1.0.

43. The product according to claim 29, wherein the polyurea copolymer has a weight average molecular weight Mw in the range of 3000 g/mol to 80,000 g/mol, determined according to the DIN 55672 or in case of high molecular weights where the polymeric material is not soluble in standard organic solvents anymore the molecular weight is determined according to the MALDI-TOF Mass Spectrometry.

44. The product according to the claim 43, wherein the polyurea copolymer has a weight average molecular weight Mw in the range of 3000 g/mol to 50,000 g/mol, determined according to the DIN 55672 or in case of high molecular weights where the polymeric material is not soluble in standard organic solvents anymore the molecular weight is determined according to the MALDI-TOF Mass Spectrometry.

45. The product according to the claim 44, wherein the polyurea copolymer has a weight average molecular weight Mw in the range of 5000 g/mol to 20,000 g/mol, determined according to the DIN 55672 or in case of high molecular weights where the polymeric material is not soluble in standard organic solvents anymore the molecular weight is determined according to the MALDI-TOF Mass Spectrometry.

46. A process for preparing a polyurea copolymer according to claim 29 comprising at least the steps of:
i) providing an isocyanate mixture (A) which has an average NCO functionality of ≥2.10;
ii) providing at least one secondary amine of formula (B), 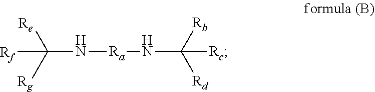
wherein Rₐ, R_{b}, Rₑ, R_{d}, Rₑ, R_{f} and R_{g} are defined as in claim 29, and
iii) contacting (A) and (B).

47. The process according to the claim 46, wherein the molar ratio of NCO in the isocyanate mixture (A) to the secondary amine (B) is in the range of ≥1.0:10 to ≤10:1.0.

48. The process according to the claim 47, wherein the molar ratio of NCO in the isocyanate mixture (A) to the secondary amine (B) is in the range of ≥1.0:2.5 to ≤2.5:1.0.

49. The process according to the claim 48, wherein the molar ratio of NCO in the isocyanate mixture (A) to the secondary amine (B) is in the range of ≥1.0:0.5 to ≤0.5:1.0.

50. The process according to claim 46, wherein step iii) carried out at a temperature in the range of ≥−50° C. to ≤250° C.

51. The process according to claim 46, wherein step iii) is carried out in the presence of at least one solvent.

52. The process according to the claim 51, wherein the at least one solvent is selected from the group consisting of ketones, esters, aromatic solvents, aliphatic solvents, ethers, lactones, carbonates, sulfones, N,N-dimethylformamide, N,N-dimethylacetamide, acetonitrile, dimethylsulfoxide, N-methyl-pyrrolidone and N-ethyl-pyrrolidone.

53. An article comprising the polyurea copolymer according to claim 29.

54. A process for reshaping a polyurea copolymer according to claim 29 comprising at least the steps of:
a) applying pressure and heat to the polyurea copolymer to obtain a heated polyurea copolymer; and
b) shaping the heated polyurea copolymer of step a).

55. The process according to the claim 54, wherein the pressure is the range of ≥5×10³ Pa to ≤10⁷ Pa.

56. The process according to the claim 55, wherein the temperature is the range of ≥60° C. to ≤300° C.
